(19) United States
(12) Patent Application Publication
(10) Pub. No.: US 2023/0421309 A1
(43) Pub. Date: Dec. 28, 2023

(54) MULTIPLE SIDELINK FEEDBACK CHANNEL OCCASION PROCEDURES

(71) Applicant: QUALCOMM INCORPORATED, San Diego, CA (US)

(72) Inventors: Stelios Stefanatos, San Diego, CA (US); Shuanshuan Wu, San Diego, CA (US); Arthur Gubeskys, San Diego, CA (US); Parisa Cheraghi, Cambridge (GB)

(21) Appl. No.: 18/253,132

(22) PCT Filed: Jan. 26, 2022
(86) PCT No.: PCT/US2022/013883

§ 371 Date: May 16, 2023

(30) Foreign Application Priority Data
Jan. 28, 2021 (GR) 20210100051

(51) Int. Cl. H04L 1/1829; H04W 72/25; H04L 1/1825

(52) U.S. Cl. CPC H04L 1/1854; H04L 1/1825; H04W 72/25; H04L 1/1861

(57) ABSTRACT

Methods, systems, and devices for wireless communications are described. One or more user equipments (UEs) may communicate in a wireless communications system by transmitting and receiving sidelink messages from other UEs. The UEs may transmit acknowledgement (ACK) or negative acknowledgment (NACK) feedback based on reception of sidelink messages for other UEs. The UEs may identify a sidelink feedback resource set including a set of feedback transmission slots for transmitting sidelink feedback. The UEs may perform NACK-only feedback, and may streamline feedback transmissions based on monitoring for other NACKs from other UEs. The UEs may prioritize feedback transmissions when the UE has multiple feedback transmissions queued, and when a UE has feedback to transmit and to receive in overlapping transmission time intervals (TTIs).

### CROSS REFERENCE

The present application is a 371 national stage filing of International PCT Application No. PCT/US2022/013883 by Stefanatos et al. entitled “MULTIPLE SIDELINK FEEDBACK CHANNEL OCCASION PROCEDURES,” filed Jan. 26, 2022; and claims priority to International Patent Application No. 20210100051 by Stefanatos et al. entitled “MULTIPLE SIDELINK FEEDBACK CHANNEL OCCASION PROCEDURES,” filed Jan. 28, 2021, each of which is assigned to the assignee hereof, and each of which is expressly incorporated by reference in its entirety herein.

### FIELD OF TECHNOLOGY

The following relates to wireless communications, including multiple sidelink feedback channel occasion procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

UEs may communicate with other UEs in unlicensed spectrum, such as in a sidelink communication system. UEs may transmit sidelink messages to other UEs, and UEs receiving sidelink messages may transmit feedback based on successful or unsuccessful reception of the sidelink messages. Feedback transmissions may interfere, be repetitive, or cause further interference.

### SUMMARY

The described techniques relate to improved methods, systems, devices, and apparatuses that support multiple sidelink feedback channel occasion procedures. Generally, the described techniques provide for user equipments (UEs) operating according to sidelink feedback procedures which may improve efficiency and decrease replicate signaling in a sidelink communications system. One or more UEs may communicate in a wireless communications system by transmitting and receiving sidelink messages from other UEs. The UEs may transmit acknowledgement (ACK) or negative acknowledgment (NACK) feedback based on reception of sidelink messages for other UEs. The UEs may identify a sidelink feedback resource set including a set of feedback transmission slots for transmitting sidelink feedback. The UEs may also perform NACK-only feedback, and may streamline feedback transmissions based on monitoring for other NACKs from other UEs. The UEs may also prioritize feedback transmissions when the UE has multiple feedback transmissions queued, and when a UE has feedback to transmit and to receive in overlapping transmission time intervals (TTIs).

### BRIEF DESCRIPTION OF THE DRAWINGS

FIG. 1 illustrates an example of a wireless communications system that supports multiple sidelink feedback channel occasion procedures in accordance with aspects of the present disclosure.

FIG. 2 illustrates an example of a wireless communications system that supports multiple sidelink feedback channel occasion procedures in accordance with aspects of the present disclosure.

FIG. 3 illustrates an example of a slot diagram that supports multiple sidelink feedback channel occasion procedures in accordance with aspects of the present disclosure.

FIG. 4 illustrates an example of a slot diagram that supports multiple sidelink feedback channel occasion procedures in accordance with aspects of the present disclosure.

FIG. 5 illustrates an example of a slot diagram that supports multiple sidelink feedback channel occasion procedures in accordance with aspects of the present disclosure.

FIG. 6 illustrates an example of a process flow that supports multiple sidelink feedback channel occasion procedures in accordance with aspects of the present disclosure.

FIG. 7 illustrates an example of a process flow that supports multiple sidelink feedback channel occasion procedures in accordance with aspects of the present disclosure.

FIG. 8 illustrates an example of a process flow that supports multiple sidelink feedback channel occasion procedures in accordance with aspects of the present disclosure.

FIGS. 9 and 10 show block diagrams of devices that support multiple sidelink feedback channel occasion procedures in accordance with aspects of the present disclosure.

FIG. 11 shows a block diagram of a communications manager that supports multiple sidelink feedback channel occasion procedures in accordance with aspects of the present disclosure.

FIG. 12 shows a diagram of a system including a device that supports multiple sidelink feedback channel occasion procedures in accordance with aspects of the present disclosure.

FIGS. 13 through 16 show flowcharts illustrating methods that support multiple sidelink feedback channel occasion procedures in accordance with aspects of the present disclosure.

### DETAILED DESCRIPTION

Two or more user equipments (UEs) may operate in a wireless communication system, such as a vehicle to vehicle (V2V) or vehicle to everything (V2X) system. In these systems, the UEs may directly communicate with other UEs, for example without messages being relayed through a base station or the network. The wireless communication system may be deployed in a licensed or unlicensed band.

In some cases, a first UE may transmit a sidelink message (e.g., sidelink data) to a second UE in a sidelink communications system (e.g., V2V or V2X). The first UE (e.g., a transmitting UE) may expect to receive a feedback message from the second UE (e.g., a receiving UE). The feedback may include an acknowledgment (ACK) or a negative acknowledgment (NACK). In these cases, the feedback transmission may occur over a sidelink feedback channel, such as a physical sidelink feedback channel (PSFCH). The feedback may occur at a single time slot (e.g., time interval), such as a PSFCH slot, which may be preconfigured by the network. The network may indicate the preconfigured PSFCH slot to both transmitting and receiving UEs in order for transmitting UEs to be made aware of when to expect to receive feedback, and for receiving UEs to receive scheduling information of available slots for transmission of feedback. Thus, receiving UEs may be aware of available slots for transmission of feedback.

Prior to transmitting feedback, a receiving UE may perform a channel access procedure, such as a listen before talk (LBT) procedure or a clear channel assessment (CCA) procedure. The channel access procedure may indicate to the UE whether the PSFCH channel is available for transmission. The receiving UE may perform the LBT procedure before the preconfigured PSFCH slot to determine whether the channel will be available during the preconfigured PSFCH slot. For example, the UE may determine, based on the LBT procedure, that the PSFCH channel will be available during the preconfigured PSFCH slot. As a result, the UE may transmit the feedback during the preconfigured PSFCH slot. However, the LBT procedure may determine that the channel may not be available during the preconfigured PSFCH slot. Therefore, the UE may not transmit the feedback during the preconfigured PSFCH slot. Due to the fact that no other PSFCH slots have been preconfigured for the particular feedback for the sidelink message, the transmitting UE may not receive the expected feedback, which may negatively impact performance, and lead to decreased communications efficiency as the UE may continue to retransmit messages, which may or may not have been correctly received by other UEs.

Therefore, the network may utilize multiple PSFCH slots for the transmission of feedback for any given sidelink message. The multiple PSFCH slots may make up a set of PSFCH slots associated with a particular transmission. The set of PSFCH slots for a given transmission may be a PSFCH resource set. A PSFCH resource set may provide a receiving UE with multiple opportunities to transmit feedback per data transmission. The PSFCH resource set of a data transmission may include the indices of the consecutive, multiple PSFCH slots following the data transmission, that a feedback transmission can be transmitted. For example, a PSFCH resource set of size 1 may include a PSFCH slot n+3, where n may be the slot of the original data transmission. In another example, a PSFCH resource set of size 3 may include the PSFCH slots of n+3, n+7, and n+11, where n may be the slot of the original data transmission from a transmitting UE.

A PSFCH resource set of a size greater than 1 may increase the probability of the feedback being received by a transmitting UE. For example, an LBT procedure may indicate that a channel is not available for transmission during a first PSFCH slot. Therefore, the receiving UE may not transmit the feedback during the first PSFCH slot. However, due to the additional PSFCH slots available to the UE, the UE may continue to perform LBT procedures for the next consecutive PSFCH slot or slots. A later LBT procedure may determine that the channel is available for feedback transmission at one of the later PSFCH slots. Therefore, the UE may transmit the feedback at the later PSFCH slot.

However, an arbitrarily large PSFCH resource set may increase a feedback gap, which may increase latency. In another example, all of the PSFCH slots in a PSFCH set may be utilized by multiple UEs in a multicast or broadcast situation, which may unnecessarily overload the PSFCH channel. In another example, multiple feedback signals, or concurrent transmission and reception of feedback signals, may be expected in partially or fully overlapping PSFCH resource sets (i.e., PSFCH resource sets with one or more common PSFCH slots). This may cause signals to be dropped, or other disruptions in transmission and reception, due to a limit to the number of signals that may be transmitted over a single PSFCH slot.

Therefore, in order to obtain more reliable feedback transmission, one or more UEs may operate according to a set of priority and scheduling procedures. In a first case, a transmitting UE may determine the number of PSFCH slots in a PSFCH resource set for a given transmission based on a set of parameters related to the transmission. These parameters may include aspects of transmission such as, packet delay budget (PDB), the application of the transmission, the priority of the packet, or any combination of these. In some examples, the priority (e.g., the priority level) of the packet (e.g., a data packet) may correspond to a priority in scheduling resources for the corresponding data packet to be transmitting Additionally or alternatively, the network may determine a system wide PSFCH slot limit. The limit may be a maximum size of a PSFCH resource set. Limiting the number of PSFCH slots may prevent increased latency due to an arbitrarily large number of PSFCH slots.

In a broadcast situation, where a transmitting UE may be operating in NACK-only mode, a single NACK transmitted by any receiving UE and received by the transmitting UE may trigger the transmitting UE to retransmit the original transmission. In these cases, other receiving UEs, which may have attempted to transmit the same NACK signal, but were not able to use LBT, may determine whether another receiving UE has already successfully transmitted the same NACK feedback to the transmitting UE, for the same sidelink message. In the case where NACK feedback has already been sent, one or more receiving UEs may not transmit its own NACK feedback. However, the receiving UE may still receive a retransmission sent from the transmitting UE due to the retransmission triggered by the first receiving UE that successfully transmitted NACK feedback. Therefore, receiving UEs determining whether a NACK was already transmitted by another UE, may prevent the PSFCH channel from becoming overloaded due to multiple receiving UEs sending the same NACK feedback over multiple PSFCH slots in a PSFCH resource set.

In another case, a prioritization procedure may be implemented in order to resolve conflicts that may arise due to multiple pending feedback transmissions, receptions, or both, over the same PSFCH slot belonging to more than one PSFCH resource sets. The prioritization procedure may be based on the expiration of the feedback, the priority of the feedback's corresponding transmission, or both. By prioritizing feedback transmissions when multiple feedback transmissions, receptions, or both, are pending, UEs communicating in a sidelink system may decrease the number of dropped feedback transmissions. Prioritizing which feedback to transmit or receive may also ensure that a dropped feedback transmission may be a lower priority feedback transmission.

Therefore, one or more UEs may decrease latency and improve communications efficiency by establishing a PSFCH resource set, and determining whether to transmit feedback based on a set of parameters and prioritization procedures.

Aspects of the disclosure are initially described in the context of wireless communications systems. Aspects of the disclosure are then described in the context of slot diagrams and process flows. Aspects of the disclosure are further illustrated by and described with reference to apparatus diagrams, system diagrams, and flowcharts that relate to multiple sidelink feedback channel occasion procedures.

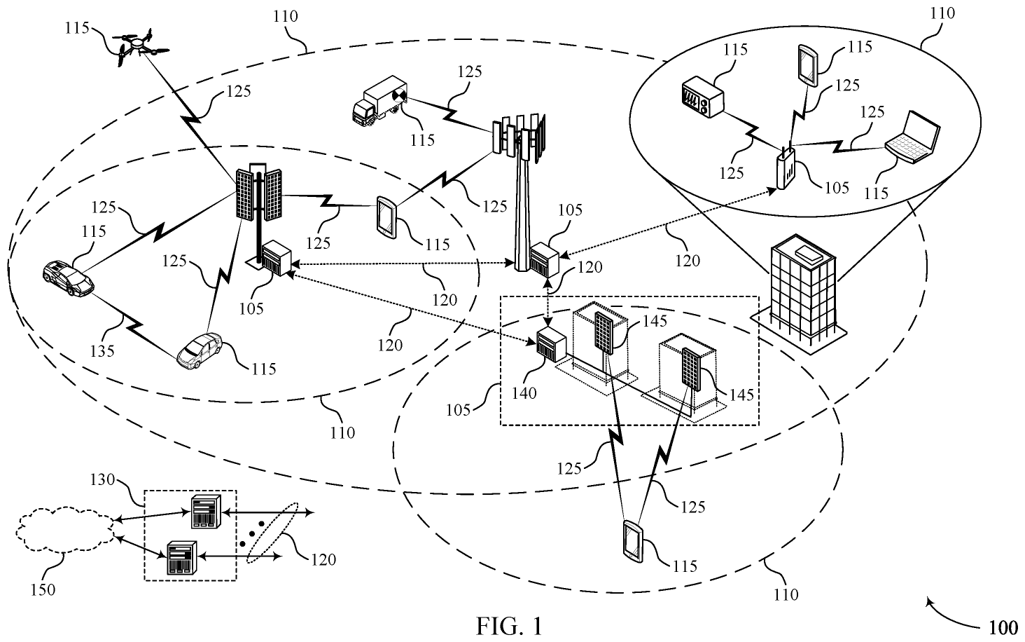

FIG. 1 illustrates an example of a wireless communications system 100 that supports multiple sidelink feedback channel occasion procedures in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using V2X communications, V2V communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

One or more UEs 115 may communicate in a wireless communications system by transmitting and receiving sidelink messages from other UEs 115. The UEs 115 may transmit ACK or NACK feedback based on reception of sidelink messages for other UEs 115. The UEs 115 may identify a sidelink feedback resource set including a set of feedback transmission slots for transmitting sidelink feedback. The UEs 115 may also perform NACK-only feedback, and may streamline feedback transmissions based on monitoring for other NACKs from other UEs 115. The UEs 115 may also prioritize feedback transmissions when the UE 115 has multiple feedback transmissions queued, and when a UE 115 has feedback to transmit and to receive in overlapping TTIs.

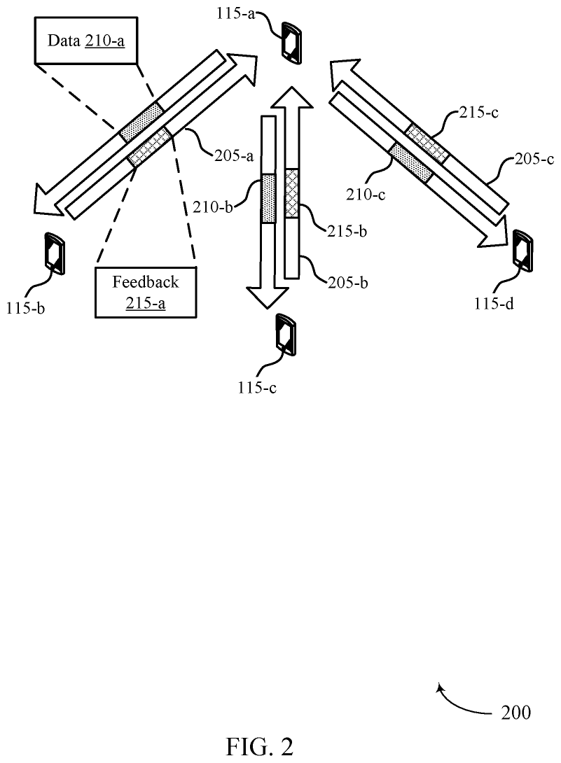

FIG. 2 illustrates an example of a wireless communications system 200 that supports multiple sidelink feedback channel occasion procedures in accordance with aspects of the present disclosure. UEs 115-a, 115-b, 115-c, and 115-d may be examples of UEs 115 as described with respect to FIG. 1. UEs 115-a, 115-b, 115-c, and 115-d may communicate in a sidelink communications system. UEs 115 may transmit sidelink data 210 to other UEs 115, and may receive feedback 215 from UEs 115 that receive sidelink data 210. UE 115-a may transmit (e.g., multicast) sidelink data 210 to each of UEs 115-b, 115-c, and 115-d. For example, UE 115-a may transmit sidelink data 210-a to UE 115-b, sidelink data 210-b to UE 115-c, and sidelink data 210-c to UE 115-d.

Each UE 115 that is scheduled to receive a sidelink data 210 message may be aware of a slot in which the UE 115 may expect to receive the sidelink data 210. Each UE 115 may monitor the slot. Based on whether the UE 115 successfully receives and decodes sidelink data 210, the UE 115 may determine whether to transmit an ACK or NACK to UE 115-a. For example, UE 115-b may not receive sidelink data 210-a, and UE 115-b may transmit feedback 215-a in sidelink feedback channel 205-a. Similarly, UE 115-c may transmit feedback 215-b in channel 205-b, and UE 115-d may transmit feedback 215-c in channel 205-c. Sidelink feedback channels 205 may be examples of PSFCHs.

UEs 115 may transmit feedback 215 according to a PSFCH resource set. The PSFCH resource set may include a number of PSFCH slots for a given transmission. The PSFCH may be determined based on a set of parameters related to the sidelink data 210. These parameters may include aspects of transmission such as, PDB, the application of the transmission, the priority of the packet, or any combination of these. Additionally or alternatively, the network may determine a system wide PSFCH slot limit. Limiting the number of PSFCH slots may prevent increased latency due to an arbitrarily large number of PSFCH slots.

UE 115-a may determine a PSFCH resource set for its transmission of sidelink data 210 to each other UE 115. UE 115-a may determine the resource set based on the PDB, application type, and priority of the packed in sidelink data 210. Each transmitting UE 115 may determine a separate PSFCH resource set for sidelink transmissions. Therefore, UEs 115 determining a resource set may indicate the size of the resource set to receiving UEs 115. UE 115-a may transmit an indication of the PSFCH resource set for the sidelink data 210 transmission to each UE 115-b, 115-c, and 115-d. The indication of the resource set may be included as part of the transmission. For example, the indication may be included in sidelink control information (SCI) transmitted in a physical sidelink control channel (PSCCH). The indication may include the number of PSFCH slot following the transmission over which a feedback 215 transmission is expected by UE 115-a. For example, a PSFCH resource set of 1 may include a PSFCH slot n+3, where n may be the slot of the sidelink data 210-a (e.g., the original data) transmission. In another example, a PSFCH resource set of 3 may include the PSFCH slots of n+3, n+7, and n+11, where n may be the slot of the sidelink data 210-a (e.g., the original data) transmission from UE 115-a. There may be a network-configured maximum resource set size. In these cases, the determined PSFCH resource set size may not exceed the network maximum.

In some cases, a standard or global PSFCH resource set size may be configured system-wide by the network. In these cases, transmitting UEs 115, such as UE 115-a, may each expect feedback according to the network-set size. Each receiving UE 115-b, 115-c, and 115-d may transmit feedback 215 based on the standard resource set size. Thus, UEs 115-b, 115-c, and 115-d may receive an indication of a resource set size, monitor for the sidelink data 210 from UE 115-a, and transmit feedback 215 in a PSFCH resource according to the resource set size.

In some cases, UEs 115-b, 115-c, and 115-d may be configured to transmit NACK feedback only. In these cases, receiving UEs 115 may transmit feedback 215 (e.g., NACK feedback) in cases where the UE 115 does not receive sidelink data 210 successfully. In cases where the UEs 115 receive sidelink data 210 successfully, the UEs 115 may not transmit feedback 215 (e.g., ACK feedback).

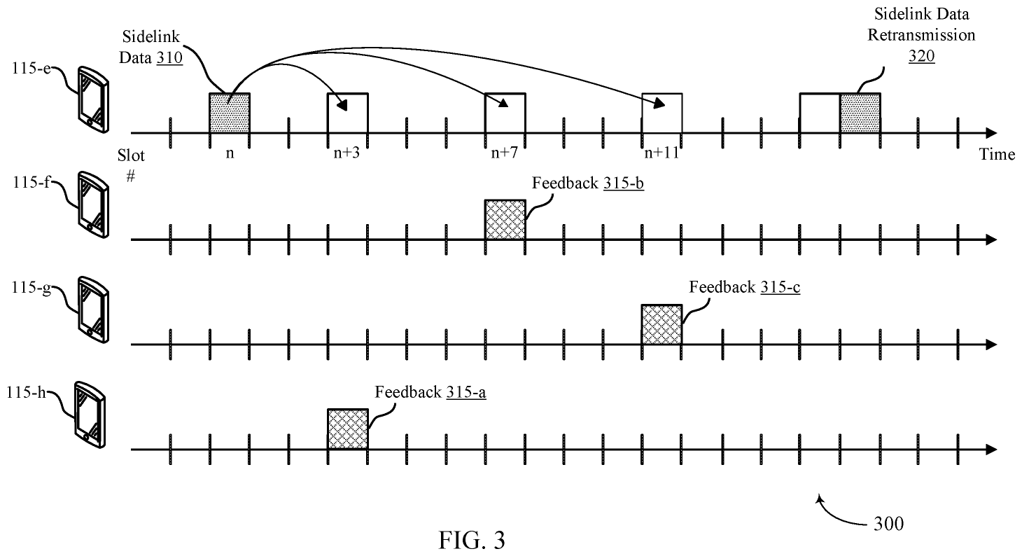

FIG. 3 illustrates an example of a slot diagram 300 that supports multiple sidelink feedback channel occasion procedures in accordance with aspects of the present disclosure. UE 115-e may be an example of UE 115-a as described with respect to FIG. 2. UEs 115-f, 115-g, and 115-h may be examples of UEs 115-b, 115-c, and 115-d, as described with respect to FIG. 2. UEs 115 may be configured in a NACK-only configuration, where UEs 115 may (e.g., only) transmit NACK feedback in the case of an unsuccessful reception, but do not transmit and ACK feedback in the case of a successful reception.

UE 115-e may transmit an initial sidelink data 310 transmissions. Sidelink data 310 may be a multicast or broadcast message which is transmitted to each of UEs 115-f, 115-g, and 115-h. UE 115-a may transmit sidelink data 310 in slot n. UEs 115 may be configured in a NACK-only configuration, where UEs 115 may (e.g., only) transmit NACK feedback in the case of an unsuccessful reception, but do not transmit and ACK feedback in the case of a successful reception.

In some cases, there may be high interference or other communications disruptions, and each of UEs 115-f, 115-g, and 115-h may unsuccessfully receive or decode sidelink data 310. In these cases, UEs 115-f, 115-g, and 115-h may schedule transmission of NACK feedback 315. The UEs 115 may schedule NACK feedback 315 based on a PSFCH resource set, as described herein. for example, slots n+3, n+7, and n+11 may be available for transmission of NACK feedback 315.

In some cases, due to varying local interference conditions, UE 115-h may transmit NACK feedback 315-a in slot n+3, UE 115-f may transmit NACK feedback 315-b in slot n+7, and UE 115-g may transmit NACK feedback 315-c in slot n+11. However, each NACK feedback 315 is for the same sidelink data 310. Thus, each subsequent NACK feedback 315 after an initial NACK feedback may provide no further information to UE 115-e, as UE 115-e may receive NACK feedback 315-a, and schedule sidelink data retransmission 320. Therefore, NACK feedback 315-b and 315-c may not provide further feedback data to UE 115-e.

Thus, to avoid overloading the PSFCH with unnecessary NACKs in feedback (e.g., unnecessary NACK feedbacks 315), the system may be configured such that one NACK feedback 315 transmitted is sufficient, and UEs 115 may refrain from transmitting additional NACK feedback 315, particularly in a NACK-only configuration. For example, UE 115-e may transmit sidelink data 310 in slot n. UEs 115-f, 115-g, and 115-h may attempt to receive and decode sidelink data 310, however each UE 115 may be unsuccessful. UEs 115-f, 115-g, and 115-f may perform a contention procedure to obtain access for transmitting feedback data in a first feedback slot, n+3 (e.g., based on a configured PSFCH resource set size). For example, UE 115-h may obtain access to slot n+3, and UEs 115-f and 115-g may not have access to slot n+3. UEs 115-f and 115-g may stay in a listening mode for slot n+3, to monitor. UEs 115-f and 115-g may thus be able to detect whether another UE 115, such as UE 115-h, transmits NACK feedback 315, such as NACK feedback 315-a.

UE 115-h may transmit NACK feedback 315-a for sidelink data 310. UEs 115-f and 115-g may determine that the NACK feedback 315-a transmitted in slot n+3 corresponds to the same sidelink data as the sidelink data 310 unsuccessfully received by UEs 115-f and 115-g. In these cases, UEs 115-f and 115-g may refrain from transmitting NACK feedback 315-b and NACK feedback 315-c (shown in in slots n+7 and n+11 in FIG. 3, respectively).

In some cases, UEs 115-f and 115-g may monitor slot n+3 for feedback, and may detect NACK feedback 315-a transmitted by UE 115-h in slot n+3. However, UEs 115-f and 115-g may determine that the NACK feedback 315-a is for a different data transmission from sidelink data 310. In these cases, UEs 115-f and 115-g may again perform a contention procedure for a next available slot according to the PSFCH resource set. For example, UE 115-f may obtain access to slot n+7, and may transmit NACK feedback in slot n+7 for sidelink data 310. UE 115-g may monitor slot n+7, and may determine that NACK feedback 315-b is for the same sidelink data 310 as was not correctly received by UE 115-g, and UE 115-g may refrain from transmitting additional NACK feedback 315-c. Based on receiving a single NACK feedback 315 for sidelink data 310, UE 115-e may transmit retransmission 320 of sidelink data 310.

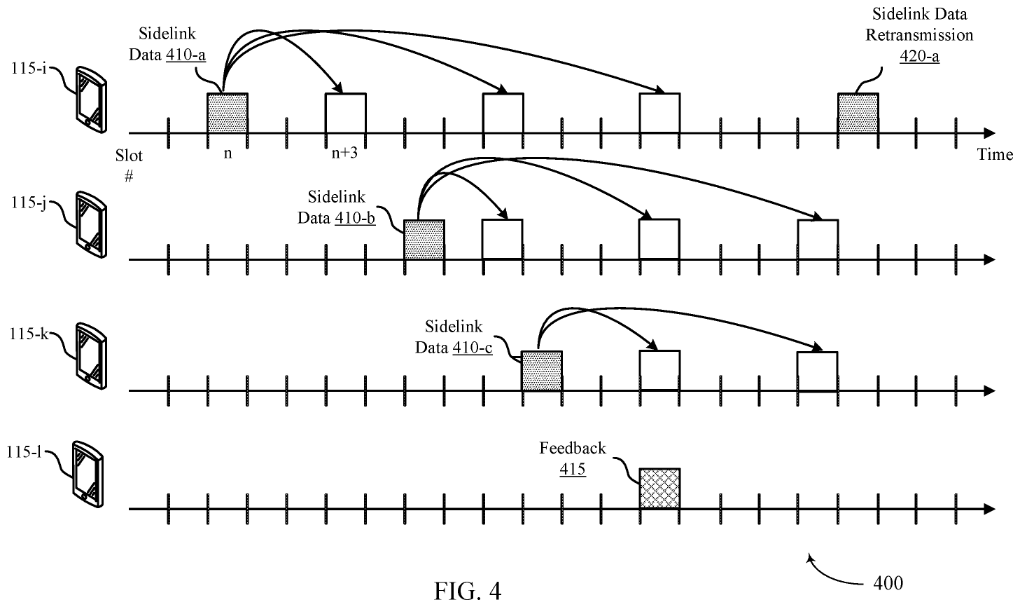

FIG. 4 illustrates an example of a slot diagram 400 that supports multiple sidelink feedback channel occasion procedures in accordance with aspects of the present disclosure. UEs 115-i, 115-j and 115-k may each transmit multicast or broadcast sidelink data 410. UE 115-i may transmit sidelink data 410-a in slot n. Sidelink data 410-a may correspond to a PSFCH resource set, including feedback slots n+3, n+7, and n+11. UE 115-j may transmit sidelink data 410-b in a later slot, such as slot n+5. Sidelink data 410-b may correspond to a PSFCH resource set, including feedback slot n+7 and n+11. UE 115-k may transmit sidelink data 410-c in a later slot, such as slot n+8. Sidelink data 410-c may correspond to a PSFCH resource set, including feedback slots n+11.

UE 115-l may be within range of each UE 115-i, 115-j, and 115-k. UE 115-l may thus receive some or all of each sidelink data 410-a, 410-b, and 410-c. However, UE 115-l may experience interference, and may unsuccessfully receive each of sidelink data 410 messages from the other UEs 115. The same interference may also inhibit UE 115-l from transmitting NACK feedback 415 in any of slots n+3 or n+7. UE 115-f may eventually obtain access to slot n+11. However, once UE 115-l is able to transmit NACK feedback in slot n+11, UE 115-l has 3 NACK transmissions queued, one for each of sidelink data 410-a, 410-b, and 410-c. However, UE 115-l may (e.g., only) be able to transmit one NACK in slot n+11.

UE 115-l may determine whether to transmit a NACK for sidelink data 410-a, sidelink data 410-b, or sidelink data 410-c. UE 115-l may make this determination based on a prioritization scheme. In a first case, UE 115-l may prioritize which feedback to transmit based on the remaining time-to-live of the feedback. The time-to-live may represent remaining PSFCH transmission attempts available. For example, using this scheme, UE 115-l may determine to transmit NACK feedback 415 for sidelink data 410-a, as sidelink data 410-a has no further PSFCH slots based on its resource set. Sidelink data 410-b may have one more slots, and sidelink data 410-c may have two more slots. For example, each PSFCH resource set for feedback for the sidelink data 410 may be of size 3.

In another case, UE 115-l may prioritize feedbacks according to the priority of the sidelink data 410. The priority of sidelink data 410 may be indicated in corresponding SCI for the sidelink data 410. For example, sidelink data 410-b may have a higher priority than sidelink data 410-a or 410-c, so UE 115-l may transmit NACK feedback 415 for sidelink data 410-b. UE 115-l may also randomly select which feedback sidelink data 410 to transmit NACK feedback 415 for. Additionally or alternatively, multiple prioritization may be combined. For example, multiple sidelink data 410 may have a same priority, so a time-to-live metric of the feedback transmission slots may be used to break the priority tie.

In some cases, a UE 115 may determine to or be configured for transmitting NACK feedback 415 in multiple slots for a same sidelink data 410. For example, UE 115-l may be configured to transmit NACK feedback 415 in each available feedback slot for a transmission, such as for sidelink data 410-a. In this case, UE 115-l may also determine a priority based on whether UE 115-l has already transmitted a NACK feedback 415 for a sidelink data 410. For example, UE 115-l may have previously transmitted NACK feedback 415 for sidelink data 410-a. Rather than transmitting the feedback again, as configured, UE 115-l may prioritize transmitting NACK feedback 415 for sidelink data 410-b. This prioritization may also be combined with a time-to-live, message priority, or randomization, or a combination of these. A UE 115 receiving a NACK feedback 415 may schedule a retransmission of the initial message, such as retransmission 420-a.

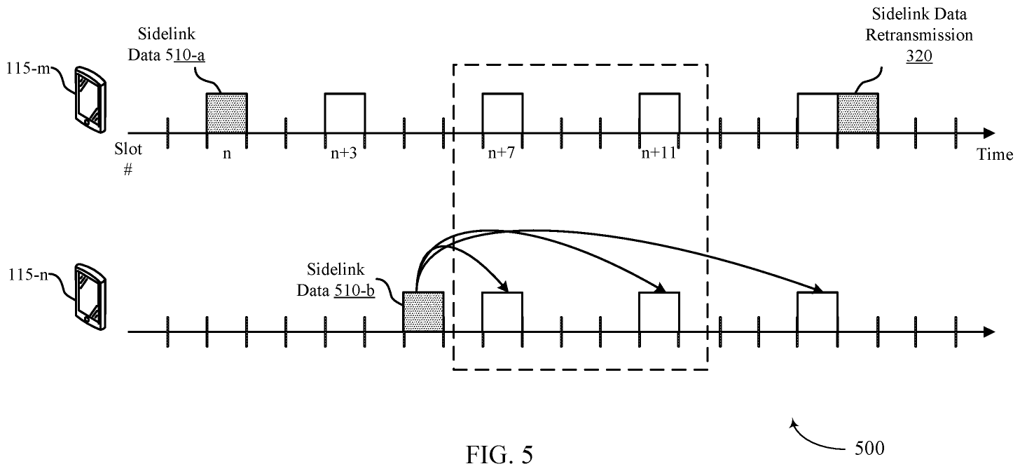

FIG. 5 illustrates an example of a slot diagram 500 that supports multiple sidelink feedback channel occasion procedures in accordance with aspects of the present disclosure. UEs 115-m and 115-n may operate in a sidelink communications system. In some cases, a transmitting UE 115 may also receive sidelink data messages from other UEs 115. For example, UE 115-m may transmit sidelink data 510-a, which may be received or detected by UE 115-n. UE 115-m may transmit sidelink data 510-a in slot n. UE 115-n may also transmit sidelink data 510-b, which may be received or detected by UE 115-m. UE 115-n may transmit sidelink data 510-b in slot n+5. Sidelink data 510-a may correspond to a PSFCH resource set, including slots n+3, n+7, and n+11. Sidelink data 510-b may correspond to a PSFCH resource set, including slots n+7, n+11, and n+15.

Based on the timing and scheduling of the transmission of sidelink data 510-a and 510-b, a UE 115 may be expected to a receive feedback for a transmission in a same slot that the UE 115 is expected to transmit feedback for a transmission. For example, UE 115-m may transmit sidelink data 510-a, and may expect feedback in one of slots n+3, n+7, and n+11. UE 115-m may also receive sidelink data 510-b from UE 115-n, and UE 115-m may identify slots n+7, and n+11 as available for feedback transmission by UE 115-m. Therefore, UE 115-m may expect to receive feedback in slot n+7, and also transmit feedback in slot n+7. The same situation may apply to UE 115-n. In cases where UE 115-m operates in a half-duplex operation, transmitting and receiving feedback in a same slot may be impossible for the UE 115 in a half-duplex configuration. Thus, UEs 115-m and 115-n may operate according to priority procedures in order to minimize this conflict.

In a first case, UEs 115-m and 115-n may prioritize based on overlapping feedback resource sets. Sidelink data 510-a may correspond to a feedback resource set that begins before the feedback resource set of sidelink data 510-b. If the resource set for receiving feedback begins first (e.g., the resource set for UE 115-m to receive feedback from UE 115-n), UE 115-m may stay in receive feedback mode until the end of the resource set for receiving feedback information for sidelink data 510-a. UE 115-m may then switch to transmitting feedback information after the end of the resource set for sidelink data 510-a, and may transmit feedback for sidelink data 510-b. Similarly, UE 115-n may determine to stay in a feedback transmit mode until the end of the resource set of sidelink data 510-a, and then UE 115-n may switch to a resource feedback mode for the rest of the resource set for sidelink data 510-b.

In another cases, UEs 115-m and 115-n may use all overlapping slots (e.g., slots n+7 and n+11) for receiving or sending feedback information, based on a priority of the messages, such as described with respect for FIG. 4. In another case, UE 115-m may receive a NACK feedback in an earlier, non-overlapping slot, and UE 115-m may switch to transmitting feedback for sidelink data 510-b after receiving the NACK. For example, UE 115-n may transmit feedback for sidelink data 510-a in slot n+3 (e.g., non-overlapping). UE 115-m may then switch to transmitting feedback in subsequent slots for sidelink data 510-b.

In another case, when there are multiple overlapping feedback slots (e.g., slot n+7 and n+11), some slots may be dedicated for transmission by UE 115-m and some for transmission by UE 115-n. The partitioning of transmitting slots for each UE 115 may be determined by the UEs 115 according to an algorithm, based on priorities, channel measurements, or other parameters.

In another case, each UE 115 may use all available slots to transmit feedback information. For example, UE 115-n may attempt to transmit feedback for sidelink data 510-a in each of slots n+3, n+7, and n+11. In cases where UE 115-n does not receive feedback for sidelink data 510-b, UE 115-n may proceed to perform a blind retransmission of sidelink data 510-b. In some cases, UE 115-n may defer from perform the retransmission if UE 115-n was able to switch to a receive feedback mode for a sufficient number of slots (e.g., a number of slots that satisfies a threshold level). The threshold level may not be the same as all of the slots in the resource set. For example, UE 115-n may transmit feedback in slots n+3 an n+7, and was able to listen for feedback in slots n+11 and n+15, then UE 115-n may refrain from retransmitting sidelink data 510-b if two slots is the threshold number of slots. The threshold number of slots may be based on the actual order or placement of the observed PSFCH slots, rather than based on a quantity of observed slots. For example, four PSFCH slots may be allocated, and two may be able to be observed by UE 115-n. However, UE 115-n may retransmit if the UE 115-n observed the first two of the four slots, and UE 115-n may not retransmit if the UE 115-n observed the last two of the four slots.

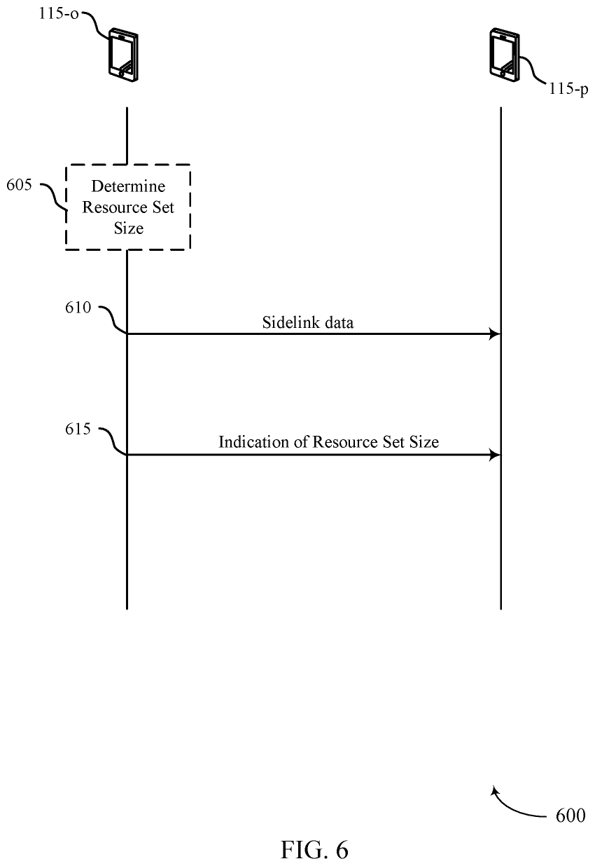

FIG. 6 illustrates an example of a process flow 600 that supports multiple sidelink feedback channel occasion procedures in accordance with aspects of the present disclosure. Process flow 600 includes UEs 115-o and UE 115-p, which may be examples of UEs 115 as described herein. UE 115-o and UE 115-p may transmit sidelink messages.

At 610, UE 115-o may transmit sidelink data in a sidelink channel. The sidelink data may correspond to one or more parameters of a set of parameters. At 615, UE 115-o may transmit an indication of a size of a resource set for a sidelink feedback channel (e.g., a PSFCH) to one or more other UEs 115, including UE 115-p. The size of the resource set may be based on the one or more parameters of the set of parameters. UE 115-o may transmit the indication in SCI in a sidelink control channel.

The size of the resource set may be a number of feedback channel TTIs (e.g., slots) following the transmission of the sidelink data. UE 115-o may determine a maximum size of the resource set. The size of the resource set may fail to exceed the maximum size. The maximum size may be preconfigured at UE 115-o by a network. The size of the resource set may correspond to a same size of a resource set of other UEs 115.

In some cases, at 605, prior to transmitting the indication, UE 115-o may determine the size of the resource set based on the one or more parameters of the set of parameters. The one or more parameters may include an application type corresponding to the sidelink data, a priority level of the sidelink data, a PDB, or a combination of these.

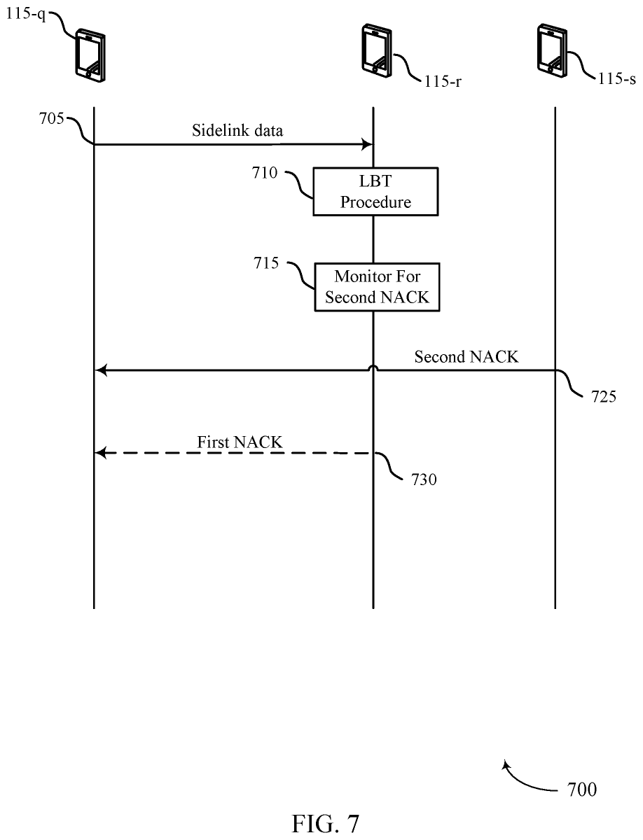

FIG. 7 illustrates an example of a process flow 700 that supports multiple sidelink feedback channel occasion procedures in accordance with aspects of the present disclosure. Process flow 700 includes UEs 115-q, UE 115-r, and UE 115-s, which may be examples of UEs 115 as described herein. UEs 115-q, UE 115-r, and UE 115-s may communicate in sidelink channels.

At 705, UE 115-r may receive sidelink data from UE 115-q. At 710, UE 115-r may perform an LBT procedure to identify availability of a first set of feedback TTIs in a sidelink feedback channel. UE 115-r may refrain from transmitting a first NACK during the first set of TTIs based on the LBT procedure.

At 715, UE 115-r may monitor for the first set of feedback TTIs for a second NACK message transmitted by a second UE 115-s. At 725, UE 115-s may transmit a second a second NACK message. UE 115-r may receive the second NACK message transmitted by the second UE 115-s in the first set of feedback TTIs. UE 115-r may decode the second NACK message.

In some cases, UE 115-s may determine that the second NACK message transmitted by second UE 115-s is the same as the first NACK message. UE 115-r may then refrain from attempting to transmit the first NACK after receiving the NACK from UE 115-s (e.g., at 730). In other cases, UE 115-r may determine that the second NACK message transmitted by UE 115-s may be different from the first NACK message queued at UE 115-r. In these cases, UE 115-r may transmit, at 730, the first NACK is a second set of TTIs after the first set of TTIs.

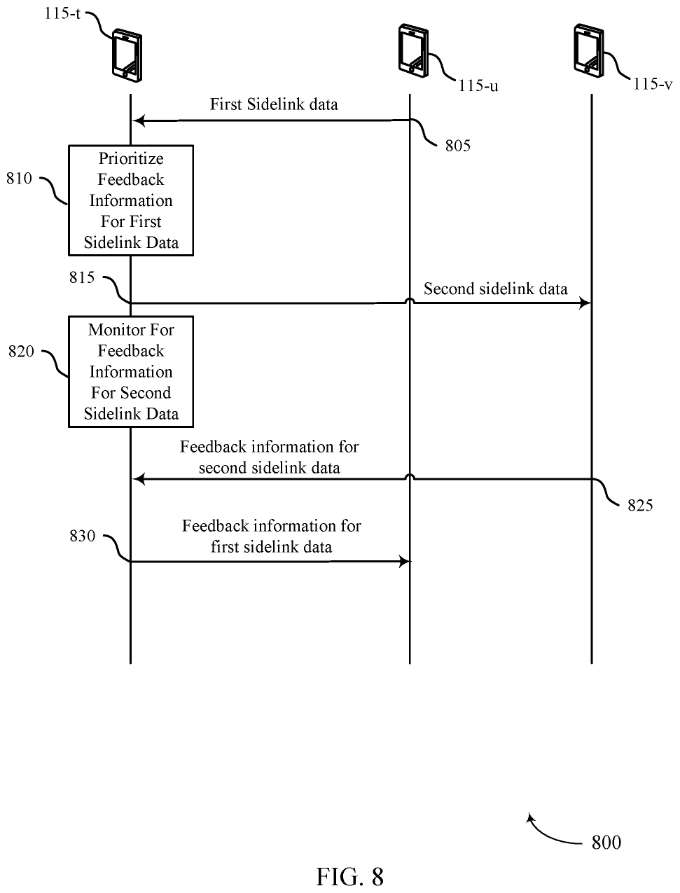

FIG. 8 illustrates an example of a process flow 800 that supports multiple sidelink feedback channel occasion procedures in accordance with aspects of the present disclosure. Process flow 800 includes UEs 115-t, UE 115-u, and UE 115-v, which may be examples of UEs 115 as described herein. UEs 115-t, UE 115-u, and UE 115-v may communicate in sidelink channels.

At 805, UE 115-t may receive a first sidelink data in a sidelink data channel. UE 115-t may receive multiple sidelink data transmissions at or after 805, including from UE 115-u and 115-v.

In some cases, at 810, UE 115-t may determine a prioritization of feedback transmissions, for transmitting feedback for received first sidelink data at 805. UE 115-t may determine the prioritization of the feedback information for the first sidelink data based on a remaining time-to-live of the feedback information for the received first sidelink data. UE 115-t may determine the prioritization of the feedback information for the first sidelink data based on a priority level of the received first sidelink data. UE 115-t may determine the prioritization of the feedback information for the first sidelink data based on a randomization. UE 115-t may determine the prioritization based at on a ranking of a remaining time-to-live of the feedback information for the first sidelink data, a priority level of the received first sidelink data, and a randomization. In some cases, UE 115-t may determine the prioritization based on the feedback information for the first sidelink data being a retransmission. UE 115-t may apply a low priority level to the feedback information based on the determining.

At 815, UE 115-t may transmit second sidelink data. UE 115-t may transmit second sidelink data at 815 to UEs 115-u and 115-v. At 820, UE 115-t may monitor a second set of feedback TTIs for feedback information for the second sidelink data from one or more UEs, such as UE 115-u or UE 115-v. UE 115-t may monitor a threshold numbers of TTIs of a second set of TTIs. UE 115-t may determine that no feedback information for the second sidelink data is received in each of the threshold number of feedback TTIs. In some cases, UE 115-t may retransmit the second sidelink data based on the determining. The retransmitting may be a blind retransmitting. In other cases, UE 115-t may refrain from retransmitting the second sidelink data based on the determining.

At 825, UE 115-t may receive feedback information from UE 115-u or UE 115-v for the second sidelink data. At 830, UE 115-t may transmit feedback information for the first sidelink data in a first set of feedback TTIs in a sidelink feedback channel based on a prioritization of the feedback information for the received first sidelink data.

In some cases, at 825, UE 115-t may receive feedback information for the second sidelink data in the second set of TTIs. UE 115-t may transmit the feedback information at 830 for the first sidelink data in the first set of TTIs, based on receiving feedback information at 825. In these cases, the second set of feedback TTIs may start before the first set of feedback TTIs, and the first set of feedback TTIs overlaps with the second set of TTIs.

In some cases, at 830, UE 115-t may transmit the feedback information for the first sidelink data in the first set of feedback TTIs. UE 115-t may then receive feedback information at 825 for the second sidelink data in the second set of feedback TTIs. In these cases, the first set of feedback TTIs may start before the second set of feedback TTIs, and the first set of feedback TTIs overlaps with the second set of feedback TTIs.

In some cases, at 825, UE 115-t may receive feedback information for the second sidelink data in the second set of feedback TTIs based on a priority of the received feedback information for the second sidelink data being higher than the transmitted feedback information for the first sidelink data. The second set of feedback TTIs may overlap with the first set of feedback TTIs.

In some cases, at 830, UE 115-t may transmit the feedback information for the first sidelink data in the first set of feedback TTIs based on a priority of the transmitted feedback information for the first sidelink data being higher than the received feedback information for the second sidelink data.

In some cases, at 825, UE 115-t may receive a NACK message for the first sidelink data from another UE, such as UE 115-v. UE 115-t may transmit the feedback information for the received first sidelink data in the first set of feedback TTIs, where the first set of feedback TTIs may overlap with the second set of feedback TTIs.

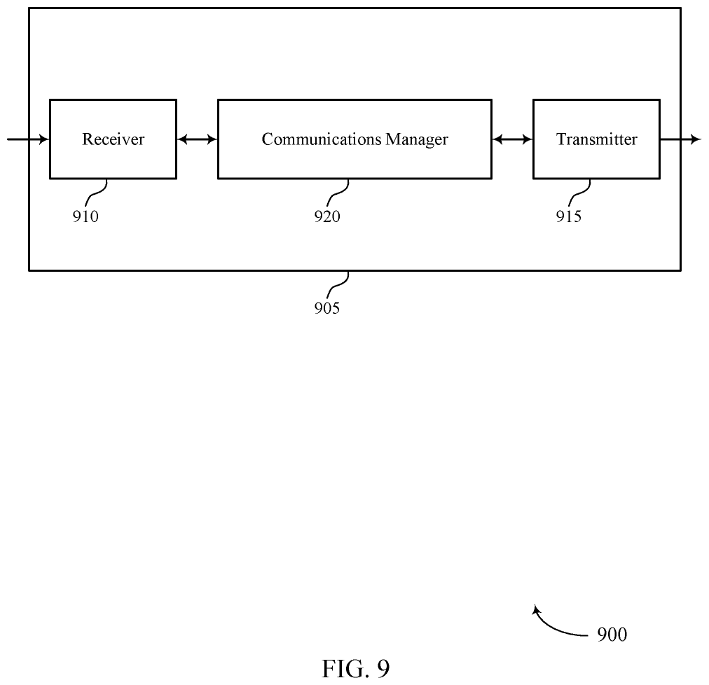

FIG. 9 shows a block diagram 900 of a device 905 that supports multiple sidelink feedback channel occasion procedures in accordance with aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to multiple sidelink feedback channel occasion procedures). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to multiple sidelink feedback channel occasion procedures). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of multiple sidelink feedback channel occasion procedures as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a UE in accordance with examples as disclosed herein. For example, the communications manager 920 may be configured as or otherwise support a means for transmitting sidelink data in a sidelink channel, the sidelink data corresponding to one or more parameters of a set of parameters. The communications manager 920 may be configured as or otherwise support a means for transmitting an indication of a size of a resource set for a sidelink feedback channel transmission to one or more UEs, where the size of the resource set is based on the one or more parameters of the set of parameters.

Additionally or alternatively, the communications manager 920 may support wireless communications at a first UE in accordance with examples as disclosed herein. For example, the communications manager 920 may be configured as or otherwise support a means for receiving sidelink data in a sidelink channel. The communications manager 920 may be configured as or otherwise support a means for performing a listen-before-talk procedure to identify availability of a first set of feedback transmission time intervals in a sidelink feedback channel. The communications manager 920 may be configured as or otherwise support a means for refraining from transmitting a first negative acknowledgment message during the first set of feedback transmission time intervals based on the listen before talk procedure. The communications manager 920 may be configured as or otherwise support a means for monitoring the first set of feedback transmission time intervals for a second negative acknowledgment message transmitted by at least a second UE.

Additionally or alternatively, the communications manager 920 may support wireless communications at a UE in accordance with examples as disclosed herein. For example, the communications manager 920 may be configured as or otherwise support a means for receiving a first sidelink data in a sidelink channel. The communications manager 920 may be configured as or otherwise support a means for transmitting feedback information for the first sidelink data in a first set of feedback transmission time intervals in a sidelink feedback channel based on a prioritization of the feedback information for the received first sidelink data.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for improving efficiency in sidelink feedback signaling between devices 905 in a sidelink communications system. The devices 905 may operate according to procedures that decrease unnecessary signaling, decrease latency, and decrease interference between devices 905.

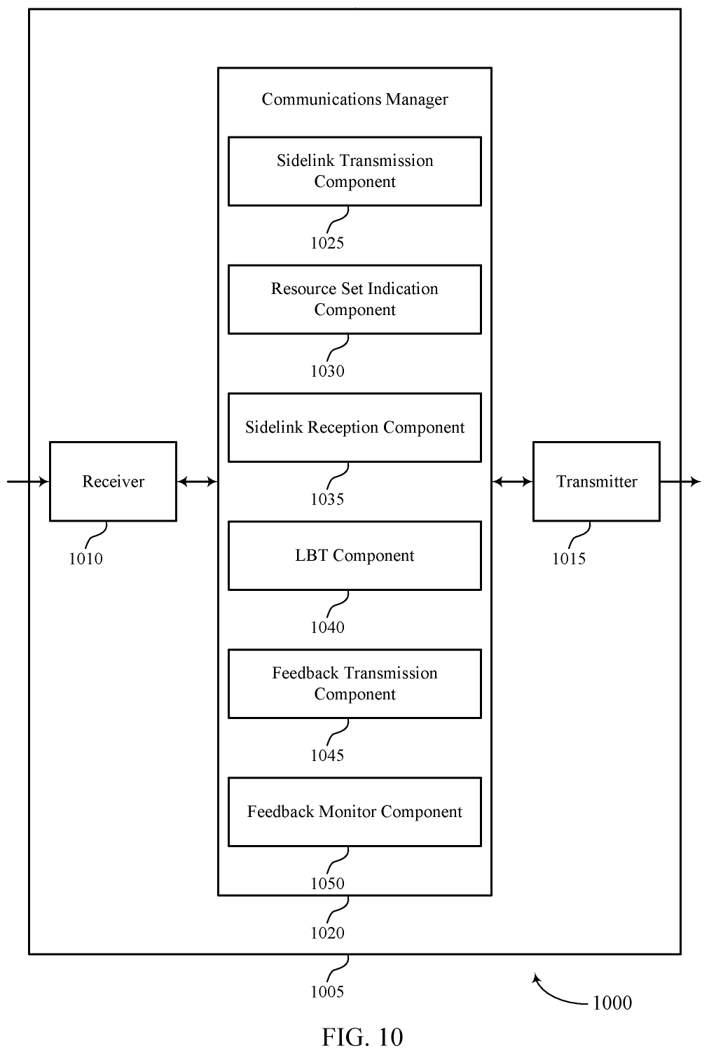

FIG. 10 shows a block diagram 1000 of a device 1005 that supports multiple sidelink feedback channel occasion procedures in accordance with aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to multiple sidelink feedback channel occasion procedures). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to multiple sidelink feedback channel occasion procedures). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of multiple sidelink feedback channel occasion procedures as described herein. For example, the communications manager 1020 may include a sidelink transmission component 1025, a resource set indication component 1030, a sidelink reception component 1035, an LBT component 1040, a feedback transmission component 1045, a feedback monitor component 1050, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a UE in accordance with examples as disclosed herein. The sidelink transmission component 1025 may be configured as or otherwise support a means for transmitting sidelink data in a sidelink channel, the sidelink data corresponding to one or more parameters of a set of parameters. The resource set indication component 1030 may be configured as or otherwise support a means for transmitting an indication of a size of a resource set for a sidelink feedback channel transmission to one or more UEs, where the size of the resource set is based on the one or more parameters of the set of parameters.

Additionally or alternatively, the communications manager 1020 may support wireless communications at a first UE in accordance with examples as disclosed herein. The sidelink reception component 1035 may be configured as or otherwise support a means for receiving sidelink data in a sidelink channel. The LBT component 1040 may be configured as or otherwise support a means for performing a listen-before-talk procedure to identify availability of a first set of feedback transmission time intervals in a sidelink feedback channel. The feedback transmission component 1045 may be configured as or otherwise support a means for refraining from transmitting a first negative acknowledgment message during the first set of feedback transmission time intervals based on the listen before talk procedure. The feedback monitor component 1050 may be configured as or otherwise support a means for monitoring the first set of feedback transmission time intervals for a second negative acknowledgment message transmitted by at least a second UE.

Additionally or alternatively, the communications manager 1020 may support wireless communications at a UE in accordance with examples as disclosed herein. The sidelink reception component 1035 may be configured as or otherwise support a means for receiving a first sidelink data in a sidelink channel. The feedback transmission component 1045 may be configured as or otherwise support a means for transmitting feedback information for the first sidelink data in a first set of feedback transmission time intervals in a sidelink feedback channel based on a prioritization of the feedback information for the received first sidelink data.

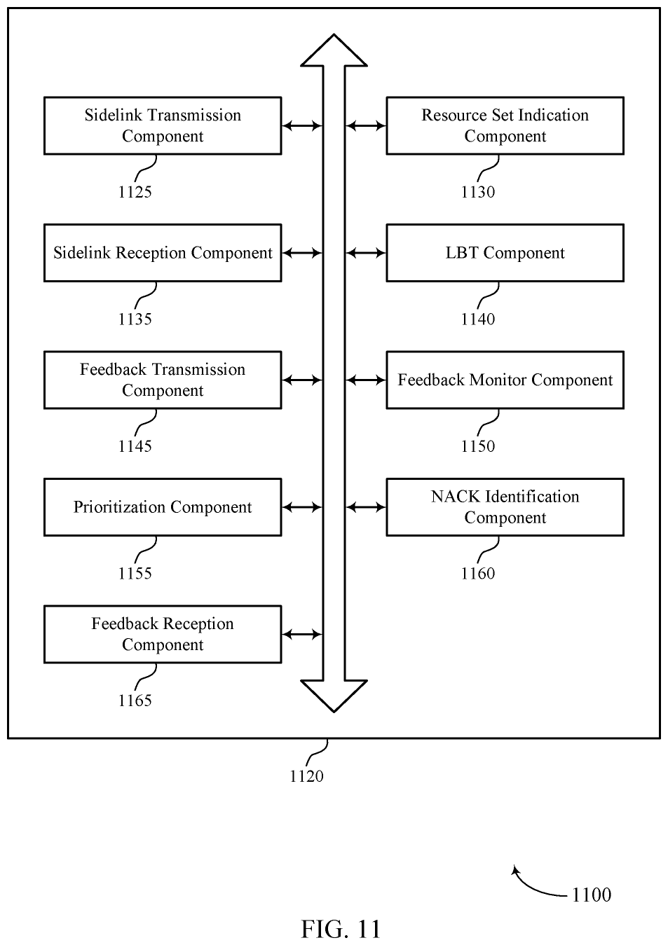

FIG. 11 shows a block diagram 1100 of a communications manager 1120 that supports multiple sidelink feedback channel occasion procedures in accordance with aspects of the present disclosure. The communications manager 1120 may be an example of aspects of a communications manager 920, a communications manager 1020, or both, as described herein. The communications manager 1120, or various components thereof, may be an example of means for performing various aspects of multiple sidelink feedback channel occasion procedures as described herein. For example, the communications manager 1120 may include a sidelink transmission component 1125, a resource set indication component 1130, a sidelink reception component 1135, an LBT component 1140, a feedback transmission component 1145, a feedback monitor component 1150, a prioritization component 1155, a NACK identification component 1160, a feedback reception component 1165, or any combination thereof. Each of these components may communicate, directly or indirectly, with one another (e.g., via one or more buses).

The communications manager 1120 may support wireless communications at a UE in accordance with examples as disclosed herein. The sidelink transmission component 1125 may be configured as or otherwise support a means for transmitting sidelink data in a sidelink channel, the sidelink data corresponding to one or more parameters of a set of parameters. The resource set indication component 1130 may be configured as or otherwise support a means for transmitting an indication of a size of a resource set for a sidelink feedback channel transmission to one or more UEs, where the size of the resource set is based on the one or more parameters of the set of parameters.

In some examples, the resource set indication component 1130 may be configured as or otherwise support a means for determining the size of the resource set based on the one or more parameters of the set of parameters.

In some examples, the one or more parameters of the set of parameters include an application type corresponding to at least one of the sidelink data, a priority level of the sidelink data, or a packet delay budget.

In some examples, the resource set indication component 1130 may be configured as or otherwise support a means for transmitting the indication in sidelink control information in a sidelink control channel.

In some examples, the size of the resource set is a number of feedback channel transmission time intervals following the transmission of the sidelink data.

In some examples, the resource set indication component 1130 may be configured as or otherwise support a means for determining a maximum size of the resource set, where the size of the resource set fails to exceed the maximum size.

In some examples, the maximum size is preconfigured at the UE by a network.

In some examples, the resource set indication component 1130 may be configured as or otherwise support a means for receiving signaling from a network indicating the maximum size.

In some examples, the size of the resource set corresponds to a same size of a resource set for other UEs.

Additionally or alternatively, the communications manager 1120 may support wireless communications at a first UE in accordance with examples as disclosed herein. The sidelink reception component 1135 may be configured as or otherwise support a means for receiving sidelink data in a sidelink channel. The LBT component 1140 may be configured as or otherwise support a means for performing a listen-before-talk procedure to identify availability of a first set of feedback transmission time intervals in a sidelink feedback channel. The feedback transmission component 1145 may be configured as or otherwise support a means for refraining from transmitting a first negative acknowledgment message during the first set of feedback transmission time intervals based on the listen before talk procedure. The feedback monitor component 1150 may be configured as or otherwise support a means for monitoring the first set of feedback transmission time intervals for a second negative acknowledgment message transmitted by at least a second UE.

In some examples, the feedback monitor component 1150 may be configured as or otherwise support a means for receiving the second negative acknowledgment message transmitted by the second UE in the first set of feedback transmission time intervals. In some examples, the feedback monitor component 1150 may be configured as or otherwise support a means for decoding the second negative acknowledgment message.

In some examples, the NACK identification component 1160 may be configured as or otherwise support a means for determining that the second negative acknowledgment message transmitted by the second UE is a same negative acknowledgment message as the first negative acknowledgment message. In some examples, the feedback transmission component 1145 may be configured as or otherwise support a means for refraining from transmitting the first negative acknowledgment message.

In some examples, the NACK identification component 1160 may be configured as or otherwise support a means for determining that the second negative acknowledgment message transmitted by the another UE is different from the first negative acknowledgment message. In some examples, the feedback transmission component 1145 may be configured as or otherwise support a means for transmitting the first negative acknowledgment message in a second set of feedback transmission time intervals after the first set of feedback transmission time intervals.

Additionally or alternatively, the communications manager 1120 may support wireless communications at a UE in accordance with examples as disclosed herein. In some examples, the sidelink reception component 1135 may be configured as or otherwise support a means for receiving a first sidelink data in a sidelink channel. In some examples, the feedback transmission component 1145 may be configured as or otherwise support a means for transmitting feedback information for the first sidelink data in a first set of feedback transmission time intervals in a sidelink feedback channel based on a prioritization of the feedback information for the received first sidelink data.

In some examples, the sidelink transmission component 1125 may be configured as or otherwise support a means for transmitting a second sidelink data. In some examples, the feedback monitor component 1150 may be configured as or otherwise support a means for monitoring a second set of feedback transmission time intervals for feedback information for the second sidelink data from one or more UEs.

In some examples, the feedback reception component 1165 may be configured as or otherwise support a means for receiving feedback information for the second sidelink data in the second set of feedback transmission time intervals. In some examples, the feedback transmission component 1145 may be configured as or otherwise support a means for transmitting the feedback information for the first sidelink data in the first set of feedback transmission time intervals based on the receiving.

In some examples, the second set of feedback transmission time intervals starts before the first set of feedback transmission time intervals, and the first set of feedback transmission time intervals overlaps with the second set of feedback transmission time intervals.

In some examples, the feedback transmission component 1145 may be configured as or otherwise support a means for transmitting the feedback information for the first sidelink data in the first set of feedback transmission time intervals. In some examples, the feedback reception component 1165 may be configured as or otherwise support a means for receiving feedback information for the second sidelink data in the second set of feedback transmission time intervals.

In some examples, the first set of feedback transmission time intervals starts before the second set of feedback transmission time intervals, and the first set of feedback transmission time intervals overlaps with the second set of feedback transmission time intervals.

In some examples, the feedback reception component 1165 may be configured as or otherwise support a means for receiving feedback information for the second sidelink data in the second set of feedback transmission time intervals based on a priority of the received feedback information for the second sidelink data being higher than the transmitted feedback information for the first sidelink data, where the second set of feedback transmission time intervals overlaps with the first set of feedback transmission time intervals.

In some examples, the feedback transmission component 1145 may be configured as or otherwise support a means for transmitting the feedback information for the first sidelink data in the first set of feedback transmission time intervals based on a priority of the transmitted feedback information for the first sidelink data being higher than the received feedback information for the second sidelink data.

In some examples, the NACK identification component 1160 may be configured as or otherwise support a means for receiving a negative acknowledgment message for the first sidelink data from a second UE. In some examples, the feedback transmission component 1145 may be configured as or otherwise support a means for transmitting the feedback information for the received first sidelink data in the first set of feedback transmission time intervals, where the first set of feedback transmission time intervals overlaps with the second set of feedback transmission time intervals.

In some examples, the feedback transmission component 1145 may be configured as or otherwise support a means for transmitting the feedback information for the first sidelink data in the first set of feedback transmission time intervals and in the second set of feedback transmission time intervals, where the first set of feedback transmission time intervals overlaps with the second set of feedback transmission time intervals.

In some examples, the feedback monitor component 1150 may be configured as or otherwise support a means for monitoring a threshold number of feedback transmission time intervals of the second set of feedback transmission time intervals. In some examples, the feedback monitor component 1150 may be configured as or otherwise support a means for determining that no feedback information for the second sidelink data is received in each of the threshold number of feedback transmission time intervals.

In some examples, the sidelink transmission component 1125 may be configured as or otherwise support a means for retransmitting the second sidelink data based on the determining.

In some examples, the retransmitting includes a blind retransmitting process.

In some examples, the sidelink transmission component 1125 may be configured as or otherwise support a means for refraining from retransmitting the second sidelink data based on the determining.

In some examples, the prioritization component 1155 may be configured as or otherwise support a means for determining the prioritization of the feedback information for the first sidelink data based on a remaining time-to-live of the feedback information for the received first sidelink data.

In some examples, the prioritization component 1155 may be configured as or otherwise support a means for determining the prioritization of the feedback information for the first sidelink data based on a priority level of the received first sidelink data.

In some examples, the prioritization component 1155 may be configured as or otherwise support a means for determining the prioritization of the feedback information for the first sidelink data based on a randomization.

In some examples, the prioritization component 1155 may be configured as or otherwise support a means for determining the prioritization of the feedback information for the first sidelink data based on at least one of a ranking of a remaining time-to-live of the feedback information for the first sidelink data, a priority level of the received first sidelink data, or a randomization.

In some examples, the prioritization component 1155 may be configured as or otherwise support a means for determining the prioritization of the feedback information for the first sidelink data based on the feedback information for the first sidelink data being a retransmission. In some examples, the prioritization component 1155 may be configured as or otherwise support a means for applying a low priority level to the feedback information based on the determining.

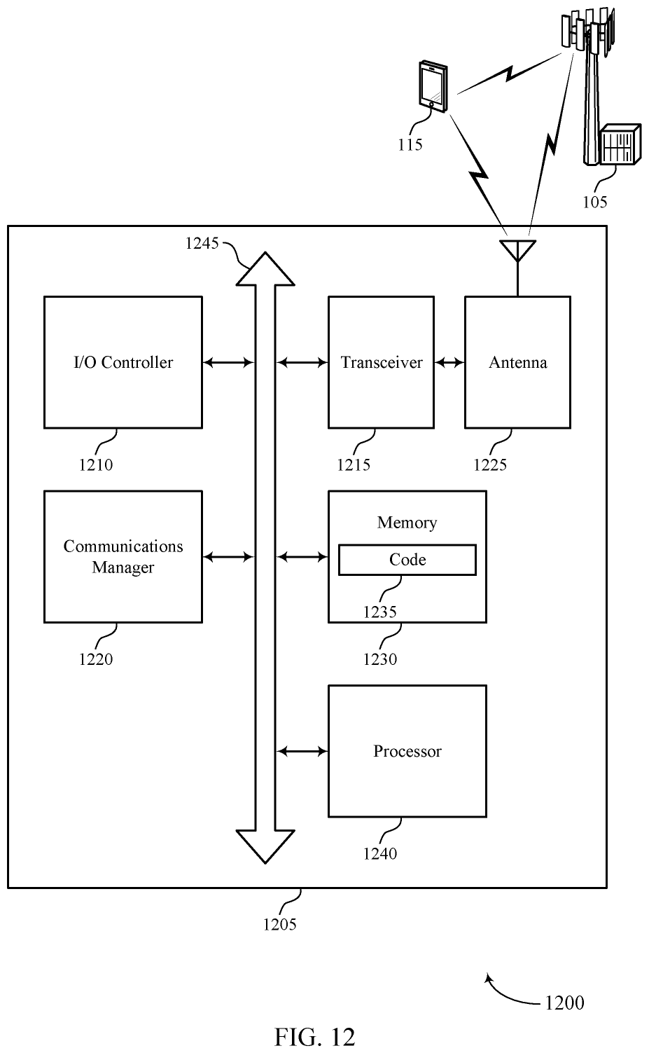

FIG. 12 shows a diagram of a system 1200 including a device 1205 that supports multiple sidelink feedback channel occasion procedures in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting multiple sidelink feedback channel occasion procedures). For example, the device 1205 or a component of the device 1205 may include a processor 1240 and memory 1230 coupled with the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for transmitting sidelink data in a sidelink channel, the sidelink data corresponding to one or more parameters of a set of parameters. The communications manager 1220 may be configured as or otherwise support a means for transmitting an indication of a size of a resource set for a sidelink feedback channel transmission to one or more UEs, where the size of the resource set is based on the one or more parameters of the set of parameters.

Additionally or alternatively, the communications manager 1220 may support wireless communications at a first UE in accordance with examples as disclosed herein. For example, the communications manager 1220 may be configured as or otherwise support a means for receiving sidelink data in a sidelink channel. The communications manager 1220 may be configured as or otherwise support a means for performing a listen-before-talk procedure to identify availability of a first set of feedback transmission time intervals in a sidelink feedback channel. The communications manager 1220 may be configured as or otherwise support a means for refraining from transmitting a first negative acknowledgment message during the first set of feedback transmission time intervals based on the listen before talk procedure. The communications manager 1220 may be configured as or otherwise support a means for monitoring the first set of feedback transmission time intervals for a second negative acknowledgment message transmitted by at least a second UE.

Additionally or alternatively, the communications manager 1220 may support wireless communications at a UE in accordance with examples as disclosed herein. For example, the communications manager 1220 may be configured as or otherwise support a means for receiving a first sidelink data in a sidelink channel. The communications manager 1220 may be configured as or otherwise support a means for transmitting feedback information for the first sidelink data in a first set of feedback transmission time intervals in a sidelink feedback channel based on a prioritization of the feedback information for the received first sidelink data.

By including or configuring the communications manager 1220 in accordance with examples as described herein, the device 1205 may support techniques for improving efficiency in sidelink feedback signaling between devices 1205 in a sidelink communications system. The devices 1205 may operate according to procedures that decrease unnecessary signaling, decrease latency, and decrease interference between devices 1205. Devices 1205 may prioritize high priority communications, and thus improve overall communications efficiency.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of multiple sidelink feedback channel occasion procedures as described herein, or the processor 1240 and the memory 1230 may be otherwise configured to perform or support such operations.

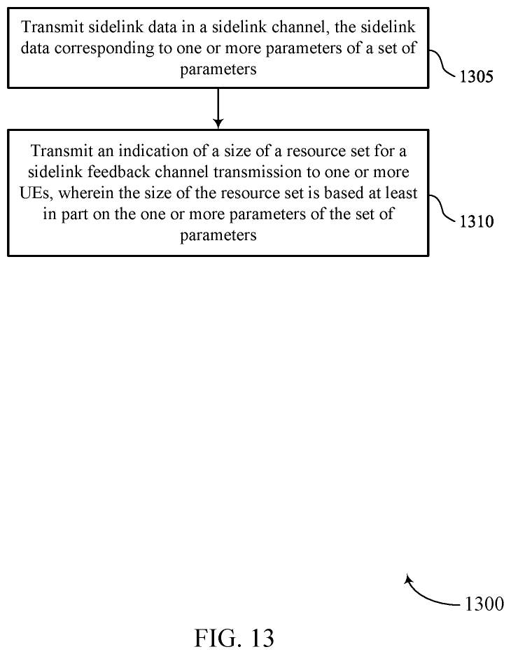

FIG. 13 shows a flowchart illustrating a method 1300 that supports multiple sidelink feedback channel occasion procedures in accordance with aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1305, the method may include transmitting sidelink data in a sidelink channel, the sidelink data corresponding to one or more parameters of a set of parameters. The operations of 1305 may be performed in accordance with examples as disclosed herein. In some examples, aspects of the operations of 1305 may be performed by a sidelink transmission component 1125 as described with reference to FIG. 11.

At 1310, the method may include transmitting an indication of a size of a resource set for a sidelink feedback channel transmission to one or more UEs, where the size of the resource set is based on the one or more parameters of the set of parameters. The operations of 1310 may be performed in accordance with examples as disclosed herein. In some examples, aspects of the operations of 1310 may be performed by a resource set indication component 1130 as described with reference to FIG. 11.

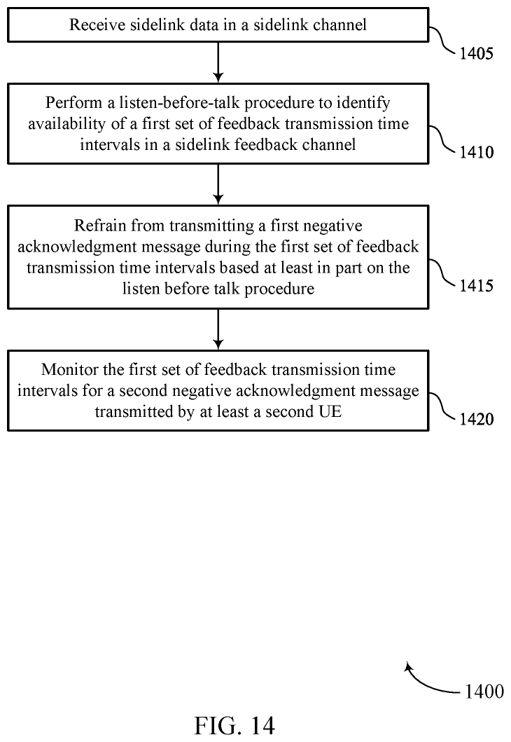

FIG. 14 shows a flowchart illustrating a method 1400 that supports multiple sidelink feedback channel occasion procedures in accordance with aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1405, the method may include receiving sidelink data in a sidelink channel. The operations of 1405 may be performed in accordance with examples as disclosed herein. In some examples, aspects of the operations of 1405 may be performed by a sidelink reception component 1135 as described with reference to FIG. 11.

At 1410, the method may include performing a listen-before-talk procedure to identify availability of a first set of feedback transmission time intervals in a sidelink feedback channel. The operations of 1410 may be performed in accordance with examples as disclosed herein. In some examples, aspects of the operations of 1410 may be performed by an LBT component 1140 as described with reference to FIG. 11.

At 1415, the method may include refraining from transmitting a first negative acknowledgment message during the first set of feedback transmission time intervals based on the listen before talk procedure. The operations of 1415 may be performed in accordance with examples as disclosed herein. In some examples, aspects of the operations of 1415 may be performed by a feedback transmission component 1145 as described with reference to FIG. 11.

At 1420, the method may include monitoring the first set of feedback transmission time intervals for a second negative acknowledgment message transmitted by at least a second UE. The operations of 1420 may be performed in accordance with examples as disclosed herein. In some examples, aspects of the operations of 1420 may be performed by a feedback monitor component 1150 as described with reference to FIG. 11.

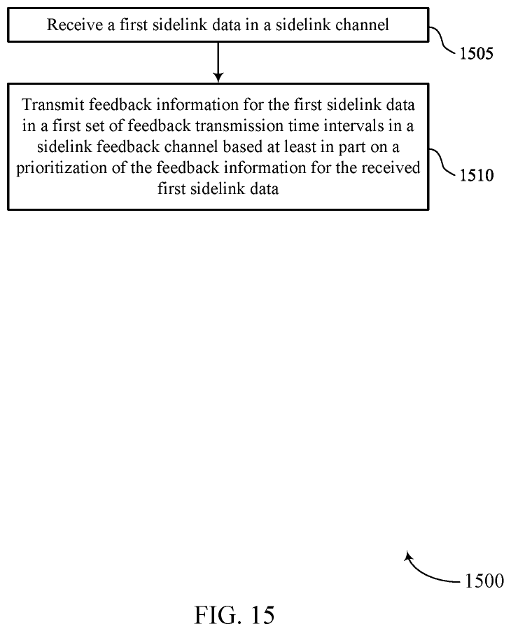

FIG. 15 shows a flowchart illustrating a method 1500 that supports multiple sidelink feedback channel occasion procedures in accordance with aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1505, the method may include receiving a first sidelink data in a sidelink channel. The operations of 1505 may be performed in accordance with examples as disclosed herein. In some examples, aspects of the operations of 1505 may be performed by a sidelink reception component 1135 as described with reference to FIG. 11.

At 1510, the method may include transmitting feedback information for the first sidelink data in a first set of feedback transmission time intervals in a sidelink feedback channel based on a prioritization of the feedback information for the received first sidelink data. The operations of 1510 may be performed in accordance with examples as disclosed herein. In some examples, aspects of the operations of 1510 may be performed by a feedback transmission component 1145 as described with reference to FIG. 11.

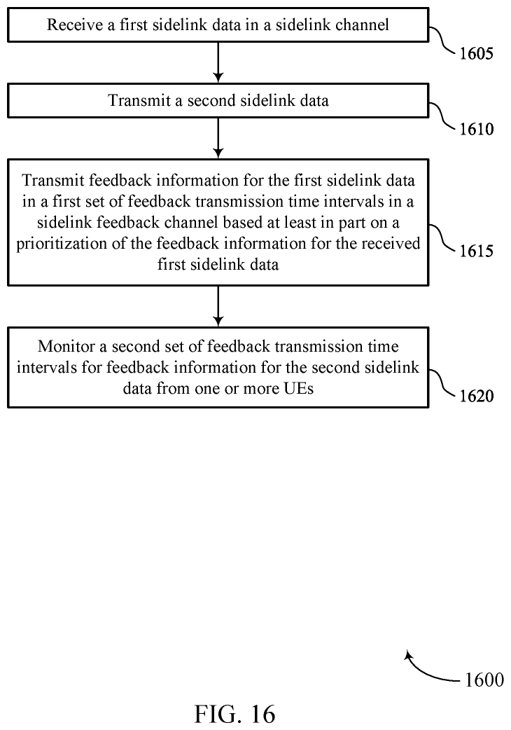

FIG. 16 shows a flowchart illustrating a method 1600 that supports multiple sidelink feedback channel occasion procedures in accordance with aspects of the present disclosure. The operations of the method 1600 may be implemented by a UE or its components as described herein. For example, the operations of the method 1600 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1605, the method may include receiving a first sidelink data in a sidelink channel. The operations of 1605 may be performed in accordance with examples as disclosed herein. In some examples, aspects of the operations of 1605 may be performed by a sidelink reception component 1135 as described with reference to FIG. 11.

At 1610, the method may include transmitting a second sidelink data. The operations of 1610 may be performed in accordance with examples as disclosed herein. In some examples, aspects of the operations of 1610 may be performed by a sidelink transmission component 1125 as described with reference to FIG. 11.

At 1615, the method may include transmitting feedback information for the first sidelink data in a first set of feedback transmission time intervals in a sidelink feedback channel based on a prioritization of the feedback information for the received first sidelink data. The operations of 1615 may be performed in accordance with examples as disclosed herein. In some examples, aspects of the operations of 1615 may be performed by a feedback transmission component 1145 as described with reference to FIG. 11.

At 1620, the method may include monitoring a second set of feedback transmission time intervals for feedback information for the second sidelink data from one or more UEs. The operations of 1620 may be performed in accordance with examples as disclosed herein. In some examples, aspects of the operations of 1620 may be performed by a feedback monitor component 1150 as described with reference to FIG. 11.

The following aspects are given by way of illustration. Examples of the following aspects may be combined with examples or embodiments shown or discussed in relation to the figures or elsewhere herein:

Aspect 1: A method for wireless communications at a UE, comprising: transmitting sidelink data in a sidelink channel, the sidelink data corresponding to one or more parameters of a set of parameters; and transmitting an indication of a size of a resource set for a sidelink feedback channel transmission to one or more UEs, wherein the size of the resource set is based at least in part on the one or more parameters of the set of parameters.

Aspect 2: The method of aspect 1, further comprising: determining the size of the resource set based at least in part on the one or more parameters of the set of parameters.

Aspect 3: The method of aspect 2, wherein the one or more parameters of the set of parameters comprise an application type corresponding to at least one of the sidelink data, a priority level of the sidelink data, or a packet delay budget.

Aspect 4: The method of any of aspects 1 through 3, further comprising: transmitting the indication in sidelink control information in a sidelink control channel.

Aspect 5: The method of any of aspects 1 through 4, wherein the size of the resource set is a number of feedback channel transmission time intervals following the transmission of the sidelink data.

Aspect 6: The method of any of aspects 1 through 5, further comprising: determining a maximum size of the resource set, wherein the size of the resource set fails to exceed the maximum size.

Aspect 7: The method of aspect 6, wherein the maximum size is preconfigured at the UE by a network.

Aspect 8: The method of any of aspects 6 through 7, further comprising: receiving signaling from a network indicating the maximum size.

Aspect 9: The method of any of aspects 1 through 8, wherein the size of the resource set corresponds to a same size of a resource set for other UEs.

Aspect 10: A method for wireless communications at a first UE, comprising: receiving sidelink data in a sidelink channel; performing a listen-before-talk procedure to identify availability of a first set of feedback transmission time intervals in a sidelink feedback channel; refraining from transmitting a first negative acknowledgment message during the first set of feedback transmission time intervals based at least in part on the listen before talk procedure; and monitoring the first set of feedback transmission time intervals for a second negative acknowledgment message transmitted by at least a second UE.

Aspect 11: The method of aspect 10, further comprising: receiving the second negative acknowledgment message transmitted by the second UE in the first set of feedback transmission time intervals; and decoding the second negative acknowledgment message.

Aspect 12: The method of aspect 11, further comprising: determining that the second negative acknowledgment message transmitted by the second UE is a same negative acknowledgment message as the first negative acknowledgment message; and refraining from transmitting the first negative acknowledgment message.

Aspect 13: The method of any of aspects 11 through 12, further comprising: determining that the second negative acknowledgment message transmitted by the another UE is different from the first negative acknowledgment message; and transmitting the first negative acknowledgment message in a second set of feedback transmission time intervals after the first set of feedback transmission time intervals.

Aspect 14: A method for wireless communications at a UE, comprising: receiving a first sidelink data in a sidelink channel; and transmitting feedback information for the first sidelink data in a first set of feedback transmission time intervals in a sidelink feedback channel based at least in part on a prioritization of the feedback information for the received first sidelink data.

Aspect 15: The method of aspect 14, further comprising: transmitting a second sidelink data; and monitoring a second set of feedback transmission time intervals for feedback information for the second sidelink data from one or more UEs.

Aspect 16: The method of aspect 15, further comprising: receiving feedback information for the second sidelink data in the second set of feedback transmission time intervals; and transmitting the feedback information for the first sidelink data in the first set of feedback transmission time intervals based at least in part on the receiving.

Aspect 17: The method of aspect 16, wherein the second set of feedback transmission time intervals starts before the first set of feedback transmission time intervals, and the first set of feedback transmission time intervals overlaps with the second set of feedback transmission time intervals.

Aspect 18: The method of any of aspects 15 through 17, further comprising: transmitting the feedback information for the first sidelink data in the first set of feedback transmission time intervals; and receiving feedback information for the second sidelink data in the second set of feedback transmission time intervals.

Aspect 19: The method of aspect 18, wherein the first set of feedback transmission time intervals starts before the second set of feedback transmission time intervals, and the first set of feedback transmission time intervals overlaps with the second set of feedback transmission time intervals.

Aspect 20: The method of any of aspects 15 through 19, further comprising: receiving feedback information for the second sidelink data in the second set of feedback transmission time intervals based at least in part on a priority of the received feedback information for the second sidelink data being higher than the transmitted feedback information for the first sidelink data, wherein the second set of feedback transmission time intervals overlaps with the first set of feedback transmission time intervals.

Aspect 21: The method of any of aspects 15 through 20, further comprising: transmitting the feedback information for the first sidelink data in the first set of feedback transmission time intervals based at least in part on a priority of the transmitted feedback information for the first sidelink data being higher than the received feedback information for the second sidelink data.

Aspect 22: The method of any of aspects 15 through 21, further comprising: receiving a negative acknowledgment message for the first sidelink data from a second UE; and transmitting the feedback information for the received first sidelink data in the first set of feedback transmission time intervals, wherein the first set of feedback transmission time intervals overlaps with the second set of feedback transmission time intervals.

Aspect 23: The method of aspect 22, further comprising: transmitting the feedback information for the first sidelink data in the first set of feedback transmission time intervals and in the second set of feedback transmission time intervals, wherein the first set of feedback transmission time intervals overlaps with the second set of feedback transmission time intervals.

Aspect 24: The method of aspect 23, further comprising: monitoring a threshold number of feedback transmission time intervals of the second set of feedback transmission time intervals; and determining that no feedback information for the second sidelink data is received in each of the threshold number of feedback transmission time intervals.

Aspect 25: The method of aspect 24, further comprising: retransmitting the second sidelink data based at least in part on the determining.

Aspect 26: The method of aspect 25, wherein the retransmitting comprises a blind retransmitting process.

Aspect 27: The method of any of aspects 24 through 26, further comprising: refraining from retransmitting the second sidelink data based at least in part on the determining.

Aspect 28: The method of any of aspects 14 through 27, further comprising: determining the prioritization of the feedback information for the first sidelink data based at least in part on a remaining time-to-live of the feedback information for the received first sidelink data.

Aspect 29: The method of any of aspects 14 through 28, further comprising: determining the prioritization of the feedback information for the first sidelink data based at least in part on a priority level of the received first sidelink data.

Aspect 30: The method of any of aspects 14 through 29, further comprising: determining the prioritization of the feedback information for the first sidelink data based at least in part on a randomization.

Aspect 31: The method of any of aspects 14 through 30, further comprising: determining the prioritization of the feedback information for the first sidelink data based at least in part on at least one of a ranking of a remaining time-to-live of the feedback information for the first sidelink data, a priority level of the received first sidelink data, or a randomization.

Aspect 32: The method of any of aspects 14 through 31, further comprising: determining the prioritization of the feedback information for the first sidelink data based at least in part on the feedback information for the first sidelink data being a retransmission; and applying a low priority level to the feedback information based at least in part on the determining.

Aspect 33: An apparatus for wireless communications at a UE, comprising a processor; memory coupled with the processor; and instructions stored in the memory and executable by the processor to cause the apparatus to perform a method of any of aspects 1 through 9.

Aspect 34: An apparatus for wireless communications at a UE, comprising at least one means for performing a method of any of aspects 1 through 9.

Aspect 35: A non-transitory computer-readable medium storing code for wireless communications at a UE, the code comprising instructions executable by a processor to perform a method of any of aspects 1 through 9.

Aspect 36: An apparatus for wireless communications at a first UE, comprising a processor; memory coupled with the processor; and instructions stored in the memory and executable by the processor to cause the apparatus to perform a method of any of aspects 10 through 13.

Aspect 37: An apparatus for wireless communications at a first UE, comprising at least one means for performing a method of any of aspects 10 through 13.

Aspect 38: A non-transitory computer-readable medium storing code for wireless communications at a first UE, the code comprising instructions executable by a processor to perform a method of any of aspects 10 through 13.

Aspect 39: An apparatus for wireless communications at a UE, comprising a processor; memory coupled with the processor; and instructions stored in the memory and executable by the processor to cause the apparatus to perform a method of any of aspects 14 through 32.

Aspect 40: An apparatus for wireless communications at a UE, comprising at least one means for performing a method of any of aspects 14 through 32.

Aspect 41: A non-transitory computer-readable medium storing code for wireless communications at a UE, the code comprising instructions executable by a processor to perform a method of any of aspects 14 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
transmit sidelink data in a sidelink channel, the sidelink data corresponding to one or more parameters of a set of parameters; and
transmit an indication of a size of a resource set for a sidelink feedback channel transmission to one or more UEs, wherein the size of the resource set is based at least in part on the one or more parameters of the set of parameters.

2. The apparatus of claim 1, wherein the instructions are further executable by the processor to cause the apparatus to:
determine the size of the resource set based at least in part on the one or more parameters of the set of parameters.

3. The apparatus of claim 2, wherein the one or more parameters of the set of parameters comprise an application type corresponding to at least one of the sidelink data, a priority level of the sidelink data, or a packet delay budget.

4. The apparatus of claim 1, wherein the instructions are further executable by the processor to cause the apparatus to:
transmit the indication in sidelink control information in a sidelink control channel.

5. The apparatus of claim 1, wherein the size of the resource set is a number of feedback channel transmission time intervals following the transmission of the sidelink data.

6. The apparatus of claim 1, wherein the instructions are further executable by the processor to cause the apparatus to:
determine a maximum size of the resource set, wherein the size of the resource set fails to exceed the maximum size.

7. The apparatus of claim 6, wherein the maximum size is preconfigured at the UE by a network.

8. The apparatus of claim 6, wherein the instructions are further executable by the processor to cause the apparatus to:
receive signaling from a network indicating the maximum size.

9. The apparatus of claim 1, wherein the size of the resource set corresponds to a same size of a resource set for other UEs.

10. An apparatus for wireless communications at a first user equipment (UE), comprising:
a processor;
memory coupled with the processor; and
instructions stored in the memory and executable by the processor to cause the apparatus to:
receive sidelink data in a sidelink channel;
perform a listen-before-talk procedure to identify availability of a first set of feedback transmission time intervals in a sidelink feedback channel;
refrain from transmitting a first negative acknowledgment message during the first set of feedback transmission time intervals based at least in part on the listen-before-talk procedure; and
monitor the first set of feedback transmission time intervals for a second negative acknowledgment message transmitted by at least a second UE.

11. The apparatus of claim 10, wherein the instructions are further executable by the processor to cause the apparatus to:
receive the second negative acknowledgment message transmitted by the second UE in the first set of feedback transmission time intervals; and
decode the second negative acknowledgment message.

12. The apparatus of claim 11, wherein the instructions are further executable by the processor to cause the apparatus to:
determine that the second negative acknowledgment message transmitted by the second UE is a same negative acknowledgment message as the first negative acknowledgment message; and
refrain from transmitting the first negative acknowledgment message.

13. An apparatus for wireless communications at a user equipment (UE), comprising:
a processor;
memory coupled with the processor; and
instructions stored in the memory and executable by the processor to cause the apparatus to:
receive a first sidelink data in a sidelink channel; and
transmit feedback information for the first sidelink data in a first set of feedback transmission time intervals in a sidelink feedback channel based at least in part on a prioritization of the feedback information for the received first sidelink data.

14. The apparatus of claim 13, wherein the instructions are further executable by the processor to cause the apparatus to:
transmit a second sidelink data; and
monitor a second set of feedback transmission time intervals for feedback information for the second sidelink data from one or more UEs.

15. The apparatus of claim 14, wherein the instructions are further executable by the processor to cause the apparatus to:
receive feedback information for the second sidelink data in the second set of feedback transmission time intervals; and
transmit the feedback information for the first sidelink data in the first set of feedback transmission time intervals based at least in part on the receiving.

16. The apparatus of claim 15, wherein the second set of feedback transmission time intervals starts before the first set of feedback transmission time intervals, and the first set of feedback transmission time intervals overlaps with the second set of feedback transmission time intervals.

17. The apparatus of claim 14, wherein the instructions are further executable by the processor to cause the apparatus to:
transmit the feedback information for the first sidelink data in the first set of feedback transmission time intervals; and
receive feedback information for the second sidelink data in the second set of feedback transmission time intervals.

18. The apparatus of claim 17, wherein the first set of feedback transmission time intervals starts before the second set of feedback transmission time intervals, and the first set of feedback transmission time intervals overlaps with the second set of feedback transmission time intervals.

19. The apparatus of claim 14, wherein the instructions are further executable by the processor to cause the apparatus to:
receive feedback information for the second sidelink data in the second set of feedback transmission time intervals based at least in part on a priority of the received feedback information for the second sidelink data being higher than the transmitted feedback information for the first sidelink data, wherein the second set of feedback transmission time intervals overlaps with the first set of feedback transmission time intervals.

20. The apparatus of claim 14, wherein the instructions are further executable by the processor to cause the apparatus to:
transmit the feedback information for the first sidelink data in the first set of feedback transmission time intervals based at least in part on a priority of the transmitted feedback information for the first sidelink data being higher than the received feedback information for the second sidelink data.

21. The apparatus of claim 14, wherein the instructions are further executable by the processor to cause the apparatus to:
receive a negative acknowledgment message for the first sidelink data from a second UE; and
transmit the feedback information for the received first sidelink data in the first set of feedback transmission time intervals, wherein the first set of feedback transmission time intervals overlaps with the second set of feedback transmission time intervals.

22. The apparatus of claim 21, wherein the instructions are further executable by the processor to cause the apparatus to:
transmit the feedback information for the first sidelink data in the first set of feedback transmission time intervals and in the second set of feedback transmission time intervals, wherein the first set of feedback transmission time intervals overlaps with the second set of feedback transmission time intervals.

23. The apparatus of claim 22, wherein the instructions are further executable by the processor to cause the apparatus to:
monitor a threshold number of feedback transmission time intervals of the second set of feedback transmission time intervals; and
determine that no feedback information for the second sidelink data is received in each of the threshold number of feedback transmission time intervals.

24. The apparatus of claim 23, wherein the instructions are further executable by the processor to cause the apparatus to:
retransmit the second sidelink data based at least in part on the determining.

25. The apparatus of claim 24, wherein the retransmitting comprises a blind retransmitting process.

26. The apparatus of claim 23, wherein the instructions are further executable by the processor to cause the apparatus to:
refrain from retransmitting the second sidelink data based at least in part on the determining.

27. The apparatus of claim 13, wherein the instructions are further executable by the processor to cause the apparatus to:
determine the prioritization of the feedback information for the first sidelink data based at least in part on a remaining time-to-live of the feedback information for the received first sidelink data.

28. The apparatus of claim 13, wherein the instructions are further executable by the processor to cause the apparatus to:
determine the prioritization of the feedback information for the first sidelink data based at least in part on at least one of a ranking of a remaining time-to-live of the feedback information for the first sidelink data, a priority level of the received first sidelink data, or a randomization.

29. The apparatus of claim 13, wherein the instructions are further executable by the processor to cause the apparatus to:
determine the prioritization of the feedback information for the first sidelink data based at least in part on the feedback information for the first sidelink data being a retransmission; and
apply a low priority level to the feedback information based at least in part on the determining.

30. A method for wireless communications at a user equipment (UE), comprising:
transmitting sidelink data in a sidelink channel, the sidelink data corresponding to one or more parameters of a set of parameters; and
transmitting an indication of a size of a resource set for a sidelink feedback channel transmission to one or more UEs, wherein the size of the resource set is based at least in part on the one or more parameters of the set of parameters.
